(19) United States
(12) Patent Application Publication
(10) Pub. No.: US 2012/0075174 A1
(43) Pub. Date: Mar. 29, 2012

(54) INPUT APPARATUS AND ELECTRONIC SYSTEM USING SAME

(75) Inventor: CHUN-WEI HO, Taipei (TW)

(73) Assignee: I Zone Technologies Co., Ltd, Taipei City (TW)

(21) Appl. No.: 12/974,951

(22) Filed: Dec. 21, 2010

(30) Foreign Application Priority Data
Sep. 28, 2010 (TW) 099132839

(51) Int. Cl. G09G 5/00

(52) U.S. Cl. 345/156

(57) ABSTRACT

An input apparatus and an electronic system using the same are provided. The input apparatus includes a casing, a sensor and a processing circuit. The casing has a first surface and a second surface arranged in opposite side. The first surface has a first input interface and the second surface has a second input interface. The sensor is disposed in the casing and is configured for sensing whether one of the first and second surfaces is towards a predetermined direction, so as to generate a sensing result. The processing circuit is arranged in the casing and is in communication with the first input interface, the second input interface and the sensor, to determine based on the sensing result whether to perform an operation according to a command inputted from the first input interface or to perform an operation according to a command inputted from the second input interface.

### FIELD OF THE INVENTION

The present invention generally relates to input apparatuses and, particularly to an input apparatus for an electronic system and an electronic system using the input apparatus.

### BACKGROUND OF THE INVENTION

Usually, a plurality of electronic systems on the markets each include two parts; one part is a host and the other part is an input apparatus for the host. Examples of the host may be televisions, computers, DVD players, set-top boxes and so on, and examples of the input apparatus may be mouse, keyboards, remote controllers and so on. The hosts can receive signals from the respective input apparatuses, and perform corresponding operations according to the received signals.

However, with the ongoing development of functions of the hosts, conventional input apparatuses with single input surfaces no longer meet requirements. For example, current televisions have been endowed with internet functions. Therefore in future, input apparatuses for the televisions are no longer simple input apparatuses with only top button, bottom button, left button, right button and numeral keys, but need further text input. However, the conventional input apparatuses with single input surface don't have any more space to arrange the text keys, therefore, the conventional input apparatuses with single input surface no longer meet the requirements for future.

### SUMMARY OF THE INVENTION

Therefore, one objective of the present invention is to provide an input apparatus which has double input surfaces and would not cause operation mistakes.

Another objective of the present invention is to provide an electronic system which employs the above input apparatus.

More specifically, an input apparatus in accordance with an embodiment of the present invention includes a casing, a sensor and a processing circuit. The casing has a first surface and a second surface, the first surface and the second surface are disposed opposite to each other. The first surface has a first input interface, and the second surface has a second input interface. The sensor is disposed in the casing, and is configured (i.e., structured and arranged) for sensing whether one of the first and second surfaces is towards a predetermined direction so as to generate a sensing result. The processing circuit is disposed in the casing, and is in communication with the first input interface, the second input interface and the sensor to determine based on the sensing result whether to perform an operation according to a command inputted from the first input interface or to perform an operation according to a command inputted from the second input interface.

An electronic system in accordance with another embodiment of the present invention includes a host and the input apparatus mentioned in the above embodiment.

According to a preferred embodiment of the present invention, the first input interface and the second input interface each include at least one of a touch control interface, a keypad interface and a press-button interface.

According to a preferred embodiment of the present invention, the sensor is a gravity sensor or a light sensor.

According to a preferred embodiment of the present invention, the sensor is a gravity sensor, and the predetermined direction is the gravity direction. When the first surface is towards the predetermined direction, the processing circuit determines to perform the operation according to the command inputted from the second input interface, and when the second surface is towards the predetermined direction, the processing circuit determines to perform the operation according to the command inputted from the first input interface.

According to a preferred embodiment of the present invention, the sensor is a light sensor, and the predetermined direction is the direction facing away from a light source. One of the first surface and the second surface has a light-transmissible (e.g., transparent) region to allow the light sensor to sense light. When the first surface is towards the predetermined direction, the processing circuit determines to perform the operation according to the command inputted from the second input interface, and when the second surface is towards the predetermined direction, the processing circuit determines to perform the operation according to the command inputted from the first input interface.

In summary, in order to overcome the drawbacks in the prior art, the embodiments of the present invention each employ two input interfaces respectively on two surfaces of the casing of the input apparatus, and have a sensor arranged in the casing to sense whether one of the first and second surfaces is towards a predetermined direction so as to generate a sensing result. The processing circuit arranged in the casing determines based on the sensing result whether to perform an operation according to a command inputted from the first input interface, or to perform an operation according to a command inputted from the second input interface. Therefore, the input apparatus of the present invention not only can be inputted by double-sided input interfaces, but also would not cause operation mistakes resulting from the user wrongly touching the input interface towards the predetermined direction.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic view of an input apparatus in accordance with an embodiment of the present invention.

FIG. 2A is a perspective view of an input apparatus in accordance with an embodiment of the present invention.

FIG. 2B is another perspective view of an input apparatus in accordance with an embodiment of the present invention.

FIG. 3 is a schematic view of an input apparatus in accordance with another embodiment of the present invention.

FIG. 4 is a schematic view of an electronic system in accordance with an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

### First Embodiment

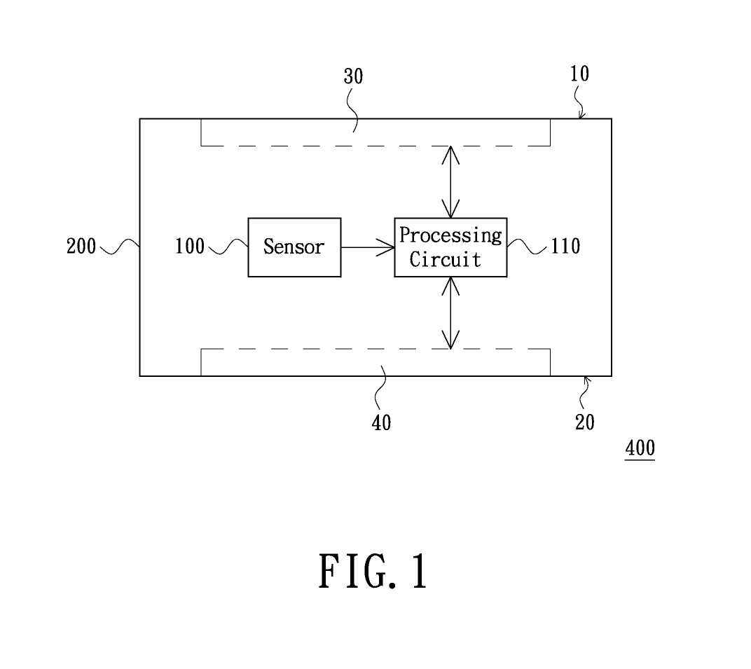

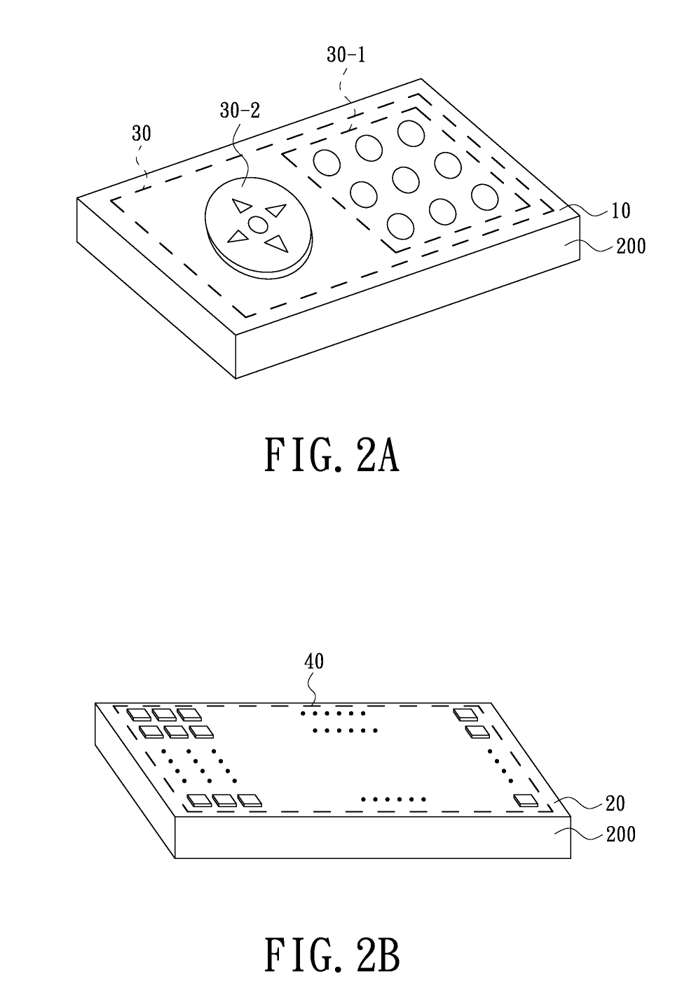

FIG. 1 is a schematic view of an input apparatus in accordance with an embodiment of the present invention. Referring to FIG. 1, the input apparatus 400 includes a casing 200, a sensor 100 and a processing circuit 110. Wherein, the casing 200 has a first surface 10 and a second surface 20, and the first surface 10 and the second surface 20 are disposed opposite to (i.e., generally facing away from) each other. For example, the first surface 10 may be a top surface of the casing 200, and the second surface 20 may be a bottom surface of the casing 200. In addition, the first surface 10 has an input interface 30 configured thereon, and the second surface 20 has another input interface 40 configured thereon. The input interfaces 30 and 40 each may include at least one of a touch control interface, a keypad interface and a press-button interface, such as shown in FIG. 2A and FIG. 2B respectively.

FIG. 2A and FIG. 2B are perspective views of the input apparatus in accordance with an embodiment of the present invention, wherein, FIG. 2A shows the first surface 10 of the casing 200 of the input apparatus 400, and FIG. 2B shows the second surface 20 of the casing 200 of the input apparatus 400 of FIG. 2A. As shown in FIG. 2A, the first surface 10 of the casing 200 of the input apparatus 400 has the input interface 30, and the input interface 30 includes a touch control interface 30-1 and a press-button interface 30-2. As shown in FIG. 2B, the second surface 20 of the casing 200 of the input apparatus 400 has the input interface 40, and the input interface 40 is a keypad interface.

Referring again to FIG. 1, the sensor 100 is mounted in the casing 200 and is configured for sensing whether one of the first surface 10 and the second surface 20 is towards a predetermined direction, so as to generate a sensing result. In the present embodiment, the sensor 100 is a gravity sensor. Therefore, the predetermined direction may be the gravity direction. The processing circuit 110 is also arranged in the casing 200 and is in communication with or electrically connected to the input interface 30, the input interface 40 and the sensor 100, to determine based on the sensing result whether to perform an operation according to a command inputted from the first input interface 30 or to perform an operation according to a command inputted from the second input interface 40. For example, if the second surface 20 of the casing 200 is towards the predetermined direction (e.g., the gravity direction), the processing circuit 110 would determine to perform the operation according to the command inputted from the input interface 30 based on the sensing result of the sensor 100. Whereas, if the first surface 10 of the casing 200 is towards the predetermined direction, the processing circuit 110 would determine to perform the operation according to the command inputted from the input interface 40 based on the sensing result of the sensor 100.

Concluded from the above description, the input apparatus of the present invention not only can be inputted by double-sided input interfaces, but also would not cause operation mistakes resulting from the user wrongly touching the input interface towards the predetermined direction.

### Second Embodiment

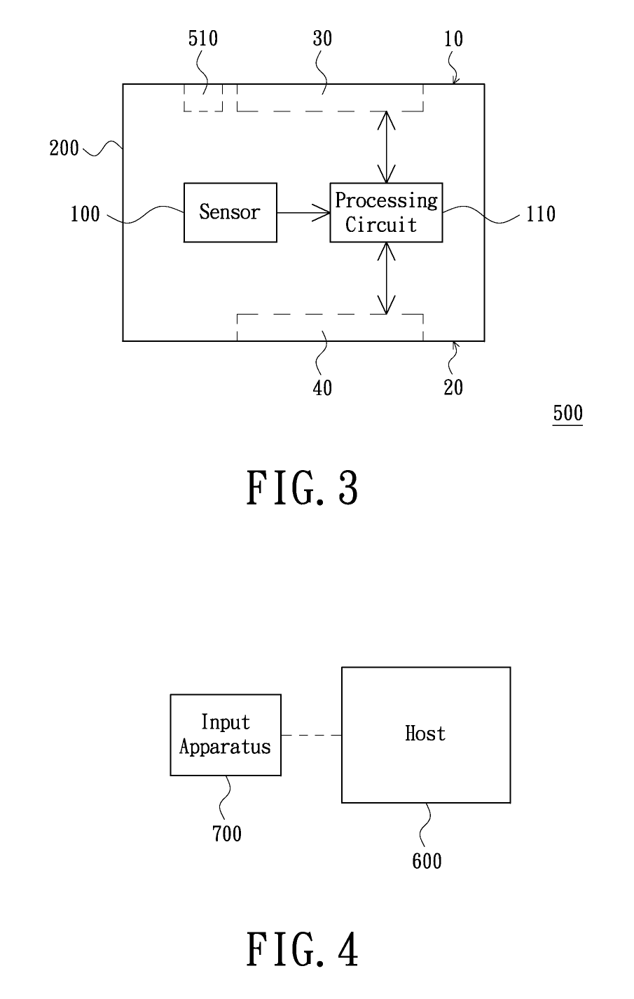

FIG. 3 is a schematic view of an input apparatus in accordance with another embodiment of the present invention. Referring to FIG. 3 together with FIG. 1, a difference between the input apparatus 500 as illustrated in FIG. 3 and the input apparatus 400 as illustrated in FIG. 1 is that: the sensor 100 of the input apparatus 500 is a light sensor instead. Because the sensor 100 of the input apparatus 500 is a light sensor, one of the first surface 10 and the second surface 20 of the casing 200 of the input apparatus 500 needs a light-transmissible (e.g., transparent) region to allow the light sensor sense light rays. In the present embodiment, the first surface 10 of the casing 200 of the input apparatus 500 has a light-transmissible e.g., transparent region 510.

Referring again to FIG. 3, when the first surface 10 is facing towards a light source (not shown), the light intensity sensed by the sensor 100 would be different from that when the first surface 10 is facing away from the light source, thereby the sensor 100 can obtain different sensing results. Based on the sensing results, the processing circuit 110 can determine which one of the first surface 10 of the casing 200 and the second surface 20 of the casing 200 is towards the predetermined direction (e.g., the direction facing away from the light source). For example, if the first surface 10 of the casing 200 is facing upwards, the processing circuit 110 can determine that the second surface 20 of the casing 200 is towards the direction facing away from the light source based on the sensing result of the sensor 100. If the second surface 20 of the casing 200 is facing upwards, the processing circuit 110 can determine that the first surface 10 of the casing 200 is towards the direction facing away from the light source based on the sensing result of the sensor 100.

Therefore, when the first surface 10 of the casing 200 is towards the predetermined direction, the processing circuit 110 can determine to perform an operation according to the command inputted from the second input interface 40, and when the second surface 20 of the casing 200 is towards the predetermined direction, the processing circuit 110 can determine to perform an operation according to the command inputted from the first input interface 30.

### Third Embodiment

FIG. 4 is a schematic view of an electronic system in accordance with an embodiment of the present invention. Referring to FIG. 4, the electronic system includes a host 600 and an input apparatus 700. The input apparatus 700 may be the input apparatus as illustrated in the first embodiment or the input apparatus as illustrated in the second embodiment. The input apparatus 700 can be connected to the host 600 by a wired manner or wireless manner to deliver signals to the host 600, such that the host 600 can perform corresponding operations according to the received signals.

To sum up, the various embodiments of the present invention each employ two input interfaces respectively on two surfaces of the casing of the input apparatus, and have a sensor arranged in the casing to sense whether one of the first and second surfaces is towards a predetermined direction, so as to generate a sensing result. The processing circuit arranged in the casing determines based on the sensing result whether to perform an operation according to a command inputted from the first input interface, or to perform an operation according to a command inputted from the second input interface. Therefore, the input apparatus of the present invention not only can be inputted by double-sided input interfaces, but also would not cause operation mistakes resulting from the user wrongly touching the input interface towards the predetermined direction.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An input apparatus comprising:
a casing comprising a first surface and a second surface, the first surface and the second surface disposed opposite to each other, the first surface having a first input interface and the second surface having a second input interface;
a sensor disposed in the casing and configured for sensing whether one of the first surface and the second surface is towards a predetermined direction, and thereby generating a sensing result; and
a processing circuit disposed in the casing and in communication with the first input interface, the second input interface and the sensor, to determine based on the sensing result whether to perform an operation according to a command inputted from the first input interface or to perform an operation according to a command inputted from the second input interface.

2. The input apparatus according to claim 1, wherein each of the first input interface and the second input interface comprises at least one of a touch control interface, a keypad interface and a press-button interface.

3. The input apparatus according to claim 1, wherein the sensor is one of a gravity sensor and a light sensor.

4. The input apparatus according to claim 3, wherein the sensor is the gravity sensor and the predetermined direction is the gravity direction, if the first surface is towards the predetermined direction, the processing circuit determines to perform the operation according to the command inputted from the second input interface, and if the second surface is towards the predetermined direction, the processing circuit determines to perform the operation according to the command inputted from the first input interface.

5. The input apparatus according to claim 3, wherein the sensor is the light sensor, the predetermined direction is a direction facing away from a light source and one of the first surface and the second surface has a light-transmissible region to allow the light sensor sense light, if the first surface is towards the predetermined direction, the processing circuit determines to perform the operation according to the command inputted from the second input interface, and if the second surface is towards the predetermined direction, the processing circuit determines to perform the operation according to the command inputted from the first input interface.

6. An electronic system comprising:
a host, and
an input apparatus for the host, the input apparatus comprising:
a casing comprising a first surface and a second surface, the first surface and the second surface disposed opposite to each other, the first surface having a first input interface and the second surface having a second input interface;
a sensor disposed in the casing and configured for sensing whether one of the first surface and the second surface is towards a predetermined direction, and thereby generating a sensing result; and
a processing circuit disposed in the casing and in communication with the first input interface, the second input interface and the sensor, to determine based on the sensing result whether to perform an operation according to a command inputted from the first input interface or to perform an operation according to a command inputted from the second input interface.

7. The electronic system according to claim 6, wherein each of the first input interface and the second input interface comprises at least one of a touch control interface, a keypad interface and a press-button interface.

8. The electronic system according to claim 6, wherein the sensor is one of a gravity sensor and a light sensor.

9. The electronic system according to claim 8, wherein the sensor is the gravity sensor and the predetermined direction is the gravity direction, if the first surface is towards the predetermined direction, the processing circuit determines to perform the operation according to the command inputted from the second input interface, and if the second surface is towards the predetermined direction, the processing circuit determines to perform the operation according to the command inputted from the first input interface.

10. The electronic system according to claim 8, wherein the sensor is the light sensor, the predetermined direction is a direction facing away from a light source, and one of the first surface and the second surface has a light-transmissible region to allow the light sensor sense light, if the first surface is towards the predetermined direction, the processing circuit determines to perform the operation according to the command inputted from the second input interface, and if the second surface is towards the predetermined direction, the processing circuit determines to perform the operation according to the command inputted from the first input interface.
